(19) United States
(12) Patent Application Publication
(10) Pub. No.: US 2025/0190699 A1
(43) Pub. Date: Jun. 12, 2025

(54) AUTOMATICALLY GENERATING AN ELECTRONIC CONVERSATION VIA NATURAL LANGUAGE MAP MODELING

(71) Applicant: PAYPAL, INC., San Jose, CA (US)

(72) Inventor: Pankaj Sarin, Fremont, CA (US)

(21) Appl. No.: 18/532,747

(22) Filed: Dec. 7, 2023

(51) Int. Cl. G06F 40/274; G06F 40/205; H04L 51/02; H04L 51/216

(52) U.S. Cl. CPC G06F 40/274; G06F 40/205; H04L 51/02; H04L 51/216

(57) ABSTRACT

A determination is made that a customer event has been initiated by a customer. The customer event is associated with a plurality of words. The plurality of words are parsed. Based on a result of the parsing of the plurality of words, an intent of the customer corresponding to the customer event is predicted. Based on the predicted intent, a first simulated service agent of a plurality of service agents is associated with the customer event. Based on the predicted intent, a first set of Natural Language Map (NLM) models for the customer and a second set of NLM models for the first simulated service agent are accessed. Based on the first set of NLM models and the second set of NLM models, a simulated conversation between the customer and the first simulated service agent is generated. The simulated conversation involves the predicted intent.

### BACKGROUND

### Field of the Invention

The present application generally relates to machine learning. More particularly, the present application involves using Natural Language Map (NLM) modeling techniques and machine learning to generate a simulated conversation between different entities.

### Related Art

Over the past several decades, rapid advances in Integrated Circuit fabrication and wired/wireless telecommunications technologies have brought about the arrival of the information age, in which electronic communications or interactions between various entities are becoming increasingly more common. For example, a user may electronically converse with an agent (which may be a real person or a computer bot) of an entity (e.g., a company) in various situations. Unfortunately, conventional methods and systems have not been able to accurately predict the content of such an electronic conversation or chat. It would be advantageous to generate a simulated electronic conversation between different parties before an actual electronic conversation takes place. An accurate simulated electronic conversation may allow the potential issues of the users to be resolved proactively, which may lead to better user satisfaction and save computing time and resources.

### BRIEF DESCRIPTION OF THE FIGURES

FIG. 1 is a block diagram of a networked system according to various aspects of the present disclosure.

FIGS. 2A, 2B, 2C collectively illustrate a simplified block diagram corresponding to a process flow for predicting an electronic conversation between different entities according to embodiments of the present disclosure.

FIG. 3 illustrates the content of some simplified example natural language map models according to various aspects of the present disclosure.

FIG. 4 illustrates an example electronic conversation according to various aspects of the present disclosure.

FIG. 5 is an example computer system according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is a flowchart illustrating a method of generating an electronic conversation according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using Natural Language Map (NLM) modeling and machine learning (ML) to automatically generate an electronic conversation. Conventionally, a user may interact with agents of a platform via one or more channels, for example, via an online chat, a telephone call, or an email. Often times, the user is engaging in such an interaction because the user needs to have one or more issues resolved (e.g., getting a refund, changing a password, submitting a dispute, etc.). Unfortunately, existing systems and methods have not been able to accurately predict the content of such an interaction. For example, existing systems and methods are unable to generate a simulated electronic conversation between a user and an agent in part or in its entirety before the simulated electronic conversation actually takes place. As a result, these platforms have not been able to fully anticipate the wishes and desires of the users ahead of time, and whatever actions taken by the platforms tend to be reactionary, rather than proactive.

In contrast, the present disclosure involves using NLP techniques and machine learning processes to predict one or more potential electronic conversations (e.g., a single conversation in some embodiments, or a plurality of conversations in other embodiments) between various entities (e.g., a user and an agent of a platform) in part or in its entirety. For example, a user (e.g., a customer) of a platform may initiate an event, for example by submitting a transaction dispute. The textual content of the event and a plurality of previous electronic chat transcripts, some of which may be associated with the user (both with a chat bot and with a human), may be analyzed, for example via natural language processing (NLP) techniques and/or machine learning processes. The analysis may be used to predict a true intent of the user in underlying the transaction. For example, although the event is a transaction dispute, the true underlying intent of the user is to get a refund issued. Based on the predicted intent, a service agent out of a plurality of agents (who may be specialized in different things) may be assigned to the user. The agents may be humans or machines, such as a chat bot. For example, the assigned agent may have skill(s) that match the skill(s) needed to help the user with the predicted intent. If the agent is a human, the assigned agent may have experience or have been trained with handling the predicted intent. If the agent is a machine, the assigned agent may have the capacity (such as through coding) to address the predicted intent. A set of natural language map (NLM) models may be generated for the user, and another set of NLM models may be generated for the assigned agent. Based on the NLM models, a simulated electronic conversation is automatically generated, where the simulated electronic conversation simulates an entire back-and-forth exchange between the user and the agent. For example, a plurality of sentences may be generated for both the user and the agent, and these sentences are sequenced accurately to mimic a real conversation. The simulated electronic conversation also addresses the predicted intent of the user. For example, when the predicted intent of the user is to get a refund, the simulated electronic conversation will address the refund issue. In some embodiments, the user will receive a notification (either through the simulated conversation or through a standalone notification) that a refund will be issued.

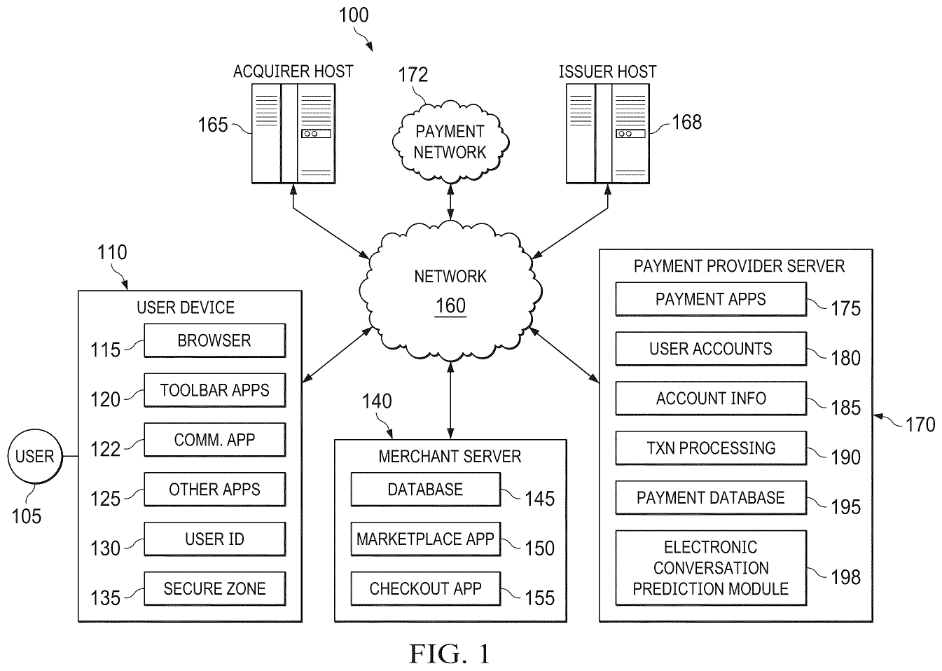

This process discussed above may occur seamlessly in the background without the user having to inform the platform of the user's underlying intent (e.g., requesting the refund). From the user's perspective, he/she may initiate an event (e.g., by submit a transaction dispute), and soon after that, the user may be informed that he/she will receive a refund associated with the transaction. In some embodiments, a recommendation may be generated for the platform, where the recommendation recommends an action for the platform to take to proactively engage with the user, for example, by offering a user a discount, a coupon, or a reward, in order to increase user satisfaction with the platform and incentivize the user to stay with the platform. As another example, the recommendation may be to prepare an agent (either a human or an electronic agent (e.g., a computer bot)) to engage in a potential interaction with the user. Since the user's underlying intent is already predicted, the potential interaction between the agent and the user may be shorter and more to-the-point. In this manner, the platform may leverage the simulated electronic conversation to turn potentially negative outcomes (e.g., the user leaving the platform due to dissatisfaction with a cumbersome and confusing process of getting a refund) into positive ones (e.g., an increase in the satisfaction of the user with the platform due to the user's underlying concern being addressed quickly and automatically, as well as potentially getting a coupon, a discount, or a reward). The various aspects of the present disclosure are discussed in more detail with reference to FIGS. 1-8.

FIG. 1 is a block diagram of a networked system 100 or architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal™, Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

According to various aspects of the present disclosure, the merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, an electronic conversation prediction (ECP) module 198 may also be implemented on the payment provider server 170. The ECP module 198 may include one or more software applications or software programs that can be automatically executed (e.g., without needing explicit instructions from a human user) to perform certain tasks. For example, the ECP module 198 may determine that a customer event (e.g., submitting a transaction dispute involving the merchant associated with the merchant server 140) has been initiated by a customer (e.g., the user 105), predict an intent of the customer based on the customer event and a historical chat record involving the customer, assign a service agent to the customer, generate natural language map (NLM) models that are customized to the customer and NLM models that are customized to the service agent, and generate a simulated electronic conversation based on the NLM models.

The ECP module 198 may also include a machine learning component that may be used to execute one or more machine learning processes. For example, a natural language processing (NLP) process as a part of (or in conjunction with) a machine learning process may be executed on textual data associated with the customer-initiated event and/or the historical electronic chat record of the customer. The intent of the customer may be more accurately predicted based on the result of the NLP and/or machine learning processes. As another example, the NLM models may be generated at least in part using machine learning as well.

Based on the above, the ECP module 198 may learn each customer's speech tendencies and the corresponding underlying intent, and it may leverage such findings to automatically generate an electronic conversation between the customer and the service agent. By doing so, the ECP module 198 can help a customer resolve an issue even before the customer needs to raise the issue. As such, electronic resources (e.g., computer processing power, electronic memory usage, network bandwidth) that would have been wasted on conducting electronic chat sessions with the user are now preserved. In this manner alone, the system 100 offers an improvement in computer technology.

It is noted that although the ECP module 198 is illustrated as being separate from the transaction processing application 190 in the embodiment shown in FIG. 1, the transaction processing application 190 may implement some, or all, of the functionalities of the ECP module 198 in other embodiments. In other words, the ECP module 198 may be integrated within the transaction processing application 190 in some embodiments. In addition, it is understood that the ECP module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the ECP module 198 may include one or more sub-modules that are configured to perform specific tasks. For example, the ECP module 198 may include a sub-module configured to predict the intent of the customer and another sub-module configured to generate the NLM models and simulate the electronic conversation.

Still referring to FIG. 1, the payment network 172 may be operated by payment card service providers or card associations, such as DISCOVER™, VISA™, MASTERCARD™ AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

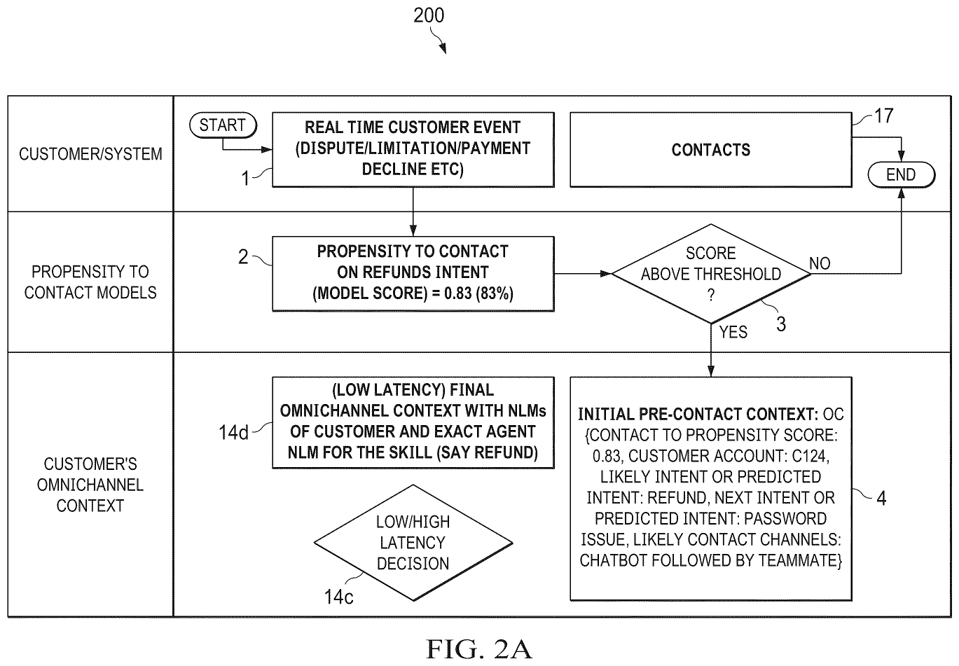

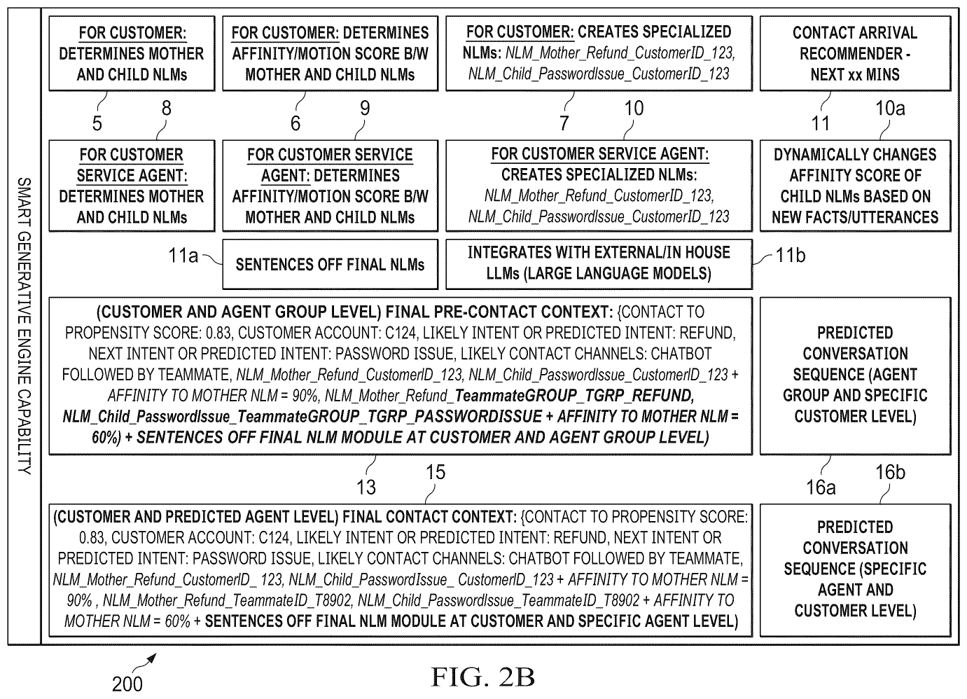

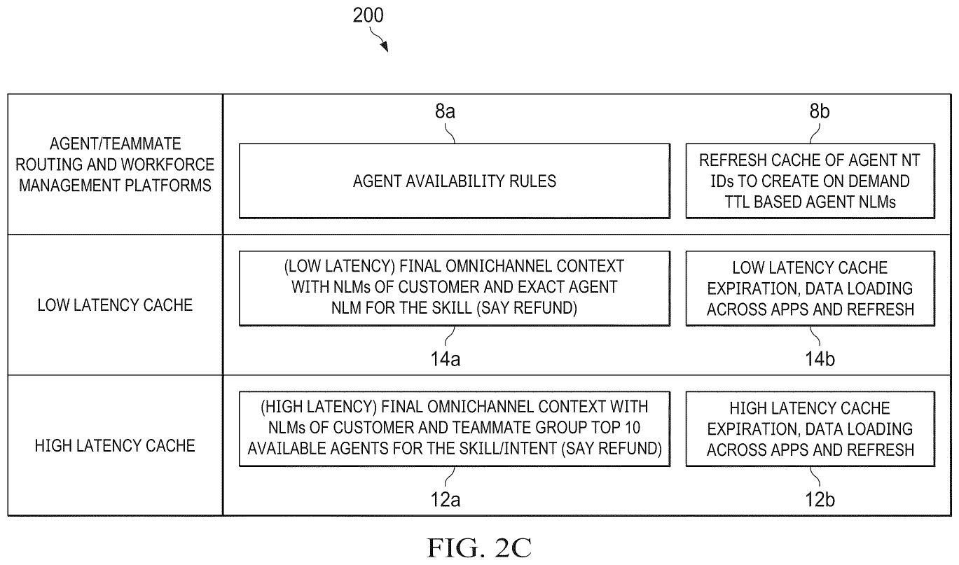

FIGS. 2A, 2B, and 2C collectively illustrate a simplified block diagram corresponding to a process flow 200 in which the ECP module 198 predicts an electronic conversation between different entities according to embodiments of the present disclosure. Each of the FIGS. 2A-2C illustrates a plurality of steps, which may reflect different aspects of the process flow 200 that are executable by the ECP module 198. In some embodiments, the different aspects may correspond to different levels at which the steps of the process flow 200 are performed. In more detail, FIG. 2A illustrates steps of the process flow 200 corresponding to the following aspects: “customer/system”, “propensity to contact models”, and “customer's omnichannel context.” FIG. 2B illustrates steps of the process flow 200 corresponding to the following aspect: “smart generative engine capability”. FIG. 2C illustrates steps of the process flow 200 corresponding to the following aspects: “agent/teammate routing and workforce management platforms”, “low latency cache”, and “high latency cache.”

The process flow 200 starts at step 1, where a real time customer event is initiated. The customer event may be initiated by a customer and detected automatically by an electronic module, such as the ECP module 198. In some embodiments, the customer event may be initiated by the customer through a website or a mobile application associated with, or accessible by, the ECP module 198. For example, after the customer successfully logs into his/her account of a platform (e.g., a third party payment provider like PayPal™) via a website of the platform or via a mobile application developed by the platform, the customer event may be initiated immediately or subsequently thereafter. As non-limiting examples, the customer event may be a dispute regarding a transaction, or it may pertain to a limitation placed on the customer's account, or it may be associated with a payment decline, etc. It is understood that although the customer has initiated the customer event, he/she has not contacted customer service at this point yet. As shown in FIG. 2A, step 1 is performed at the level of “customer/system.”

In some embodiments, the ECP module 198 may predict an intent of the customer for initiating the customer event. In that regard, the true intent of the customer may not be limited to what is specifically described in the initiated customer event, but it may cover additional concerns of the customer as well. For example, while the specific issue raised in the customer event of step 1 is a transaction dispute with a merchant, the customer's true intent (or ultimate goal) is to get a refund issued for the disputed transaction. According to the various aspects of the present disclosure, rather than relying on the customer to specifically convey that intent to the platform, the ECP module 198 may utilize natural language processing (NLP) and/or machine learning processes to parse the words associated with the customer event (and/or the historical chat record of the customer) to predict such an intent. That way, the customer's underlying concerns may be addressed proactively.

In more detail, NLP involves using the capabilities of machine learning to interpret, manipulate, and comprehend human language. One example NLP technique is word2vec, which is a group of related models that are used to produce word embeddings. The models may be shallow, two-layer neural networks that are commonly used to reconstruct linguistic contexts of words of a given language in a compact form. For a given vocabulary of words, word2vec creates “word embeddings”—mapping from each word to an n-dimensional vector. For example, “king” may be mapped to a five-dimensional vector with the value [0.8, 0.65, 1.7, 2, 4]. The word embeddings are created using the context in which the word appears, as the words that tend to appear next to it. Therefore, it is expected that words that appear in similar contexts will have similar vectors (e.g., sentences “I really like cooking in the kitchen” and “I really like baking in the kitchen”). Word2vec may take, as its input, a large corpus of text and produces a vector space, typically of several hundred dimensions (e.g., 300 dimensions to represent the English vocabulary). In the example of FIG. 2A, the corpus of text may be the words of the customer event, as well as the words in the previous electronic chat transcripts involving the customer. Each unique word in the corpus is assigned a corresponding vector in the space. Word vectors are positioned in the vector space such that words that share common contexts in the corpus are located in close proximity to one another in the space. Other embedding and training algorithms such as FastText may be used similarly like word2vec as understood by one of ordinary skill in the art. In some embodiments, sentence and/or paragraph vectors may be calculated in addition to word vectors. Thus, one or more vectors can be calculated for a customer's prior electronic conversation history. Periodically (e.g., weekly, monthly, etc.), word2vec may be run on data from the most recent period of time (e.g., week, two weeks, month, two months, six months, year, etc.) during which the customer has interacted (e.g., uttered words) with customer service agents. It is understood that other NLP techniques in conjunction with, or instead of, word2vec in order to predict the intent of the customer, which in this case is predicted to be a refund issuance.

The process flow continues at step 2, in which a propensity-to-contact score is calculated. The propensity-to-contact score is a numeric score generated by a model that predicts how likely a given customer will contact customer service following a customer event. For example, after the customer has logged in to his/her account in step 1 to file a dispute with a merchant (which is considered the initiation of a customer event), step 2 of the process flow 200 may generate or access various models to calculate a propensity-to-contact score for that customer.

In some embodiments, a different propensity-to-contact score may be calculated for each type of customer event, where the calculation of the propensity-to-contact score may be based on the history of the given customer and/or other customers having similar characteristics as that given customer. For example, a customer A may be very likely to contact customer service following the initiation of a merchant transaction dispute, but not as likely to contact customer service for a limitation placed on his/her account. On the other hand, a customer B may be less likely to contact customer service for a merchant transaction dispute, but very likely to contact customer service for a limitation placed on his/her account. In that situation, the customer A may have a propensity-to-contact score of 0.9 (in a range between 0 and 1) for the merchant transaction dispute and a propensity-to-contact score of 0.6 for the limitation placed on his/her account, whereas the customer B may have a propensity-to-contact score of 0.6 for the merchant transaction dispute and a propensity-to-contact score of 0.9 for the limitation placed on his/her account.

Of course, the above are merely non-limiting examples, and it is understood that a variety of factors (other than the history of the customer) may be utilized to calculate the propensity-to-contact score. For the purposes of facilitating the ensuing discussions, suppose that the propensity-to-contact score obtained in step 2 herein is 0.83 (or 83%), which means that the given customer is 83% likely to contact customer service after a transaction dispute when the predicted intent is for a refund. It is also understood that in some embodiments, the prediction of the intent of the customer may be performed in step 2 instead of in step 1.

The process flow 200 proceeds to step 3 following step 2. Step 3 is a decision step, in which a determination is made as to whether the propensity-to-contact score obtained from step 2 exceeds a predefined threshold. It is understood that different thresholds may be configured for different types of propensity-to-contact scores and/or for different customers. In the example of FIG. 2A, the threshold of step 3 is 0.8 (or 80%) for the propensity-to-contact score associated with refunds after a transaction dispute. Step 3 compares the propensity-to-contact score obtained in step 2 with the predefined threshold and determines whether the propensity-to-contact score is above the predefined threshold.

As shown in FIG. 2A, the process flow 200 performs different actions depending on the result of the comparison in step 3. For example, if the propensity-to-contact score obtained in step 2 is less than the predefined threshold associated with step 3, then the process flow 200 may end, meaning that no additional action needs to be performed, at least for the time being. However, if the propensity-to-contact score obtained in step 2 is greater than the predefined threshold associated with step 3, then the process flow 200 may proceed to step 4. In the simplified example of FIG. 2A, the propensity-to-contact score is 0.83, which is above the threshold is 0.8, and therefore the process flow 200 proceeds to step 4. Note that both step 2 and step 3 are performed at the level of “propensity-to-contact models.”

In step 4 of the process flow 200, an initial pre-contact context is established. The initial pre-contact context may be based on a plurality of factors, including but not limited to, the propensity-to-contact score, the name or user identifier of an account of the customer (e.g., C124 as the user identifier), the most likely or predicted intent of the customer (e.g., to request a refund), the next likely or predicted intent of the customer (e.g., to resolve a password issue), and one or more likely contact channels (e.g., an initial conversation with a computerized chatbot followed by a human customer service agent (which is also referred to as a teammate), etc. Note that the predicted intent of the customer may not have been specifically raised as a concern by the customer during step 1. In other words, the customer may have merely submitted a transaction dispute, but has not mentioned getting a refund issued yet. It is also understood that the pre-contact context is established before the customer actually contacts customer service, and it is performed at the level of “Customer's omnichannel context.”

Referring now to FIG. 2B, the process flow 200 continues to step 5, in which a mother natural language map (NLM) and a child NLM are both determined for the customer that initiated the customer event and for whom the pre-contact context was established. In some embodiments, the mother NLM and the child NLM may both include computerized models, which may be established at least in part using one or more NLP techniques such as word2vec. For example, word2vec may be used to parse through the historical electronic chat transcripts involving the customer, along with the known actions taken by or against the customer, in order to determine the NLM model for each type of customer intent (e.g., refunds versus passwords). It is understood that other NLP techniques in conjunction with, or instead of, word2vec in order to establish the mother and child NLM models. For example, some NLP techniques may utilize not just the specific words uttered by the customer in an electronic conversation, but also the speed of narration or other language characteristics.

In step 6 of the process flow 200, an affinity score (also referred to as a motion score) between the mother NLM model and the child NLM model is determined for the customer. In that regard, a mother NLM model and a child NLM model may have a relationship, where the event associated with the mother NLM model generally leads to (e.g., having a correlation above a specified threshold) the event associated with the child NLM. For example, for a specific customer, a transaction dispute with a merchant is generally followed by a request by the customer to issue a refund for the disputed transaction with the merchant. In that simple example, a mother NLM model may pertain to the transaction dispute, and the child NLM model may pertain to the request to issue a refund. Of course, there are many other candidates for the child NLM, since many different types of subsequent events may occur after a preceding event.

Using the transaction dispute again as the event for the mother NLM model, the customer could also generate different types of events, such as submitting a complaint, requesting an account status change, or requesting a password reset, as non-limiting examples. A child NLM model is established for each of these types of events, and an affinity score between each of the child NLM models and the mother NLM model is calculated. In some embodiments, the affinity score may be calculated at least in part based on the historical outcomes following the event associated with the mother NLM model for that specific customer. In other embodiments, predictive analysis may also be used to calculate the affinity score. As a non-limiting example, the affinity score may be a numeric value between 0 and 1, where 0 indicates low to no affinity between the mother NLM model and the child NLM model, and 1 indicates high affinity between the mother NLM model and the child NLM model.

In some embodiments, the ECP module 198 may first assign a mother NLM model of transaction dispute for a given customer, and then assign a specific child NLM model (out of a group of suitable child NLM model candidates) for that customer based on the affinity scores between the child NLM model candidates and the mother NLM model. For example, the child NLM model with the highest affinity score out of the group is assigned to the mother NLM model. In some embodiments, the assignment of the child NLM models may also take into account the next likely issue (e.g., next likely intent of the customer). For example, following a transaction dispute as the issue for the mother NLM model, the most likely next issue may be a request to issue a refund, and the next likely issue may be to file a complaint against the merchant. In that case, the affinity score may be the highest between the mother NLM model of transaction dispute and the child NLM model of refund issuance, and the affinity score may be the second highest between the mother NLM model of transaction dispute and the child NLM model of complaint against the merchant. The ECP module 198 may then rank these affinities and store the ranking in an electronic memory.

In step 7 of the process flow 200, specialized NLM models may be created for the customer. For example, a different type of NLM model may be established for different types of customer intents. For example, one NLM model may be established for a customer intent to get a refund, while a different NLM model may be established for a customer intent to resolve a password issue. Furthermore, it is understood that the NLM models are established for a specific customer. For example, while a customer A and a customer B may both have the intent of getting a refund, different NLM models may be established for them. The different NLM models for different customers may be attributed at least in part to the different electronic conversations associated with the customers A and B, for example, due to their different styles or manners of conversing. Thus, the NLM models generated herein are customized for individual customers.

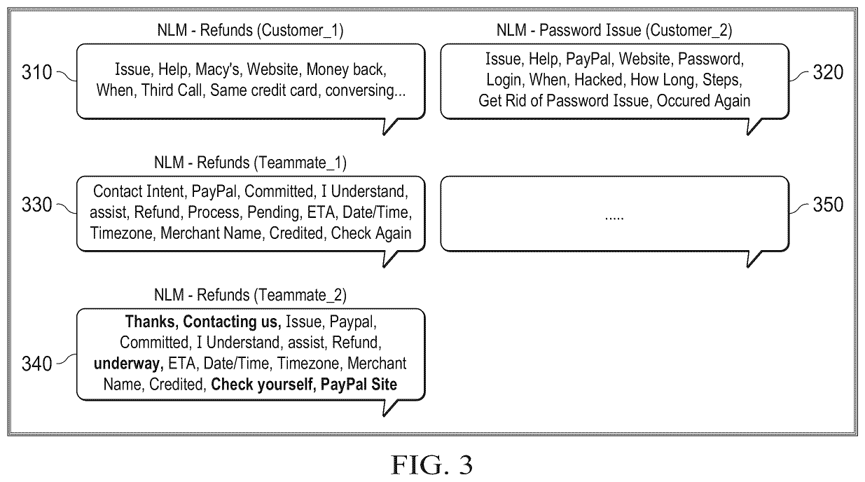

FIG. 3 illustrates the content of some simplified example NLM models for customers. For example, an NLM model 310 may be customized for a customer_1 who wishes to get refunds. Some of the key words included in the model 310 are: Issue, Help, Macy's, Website, Money back, When, Third Call, Same credit card, conversing. As another example, an NLM model 320 may be customized for a customer_2 who wishes to resolve a password issue. Some of the key words included in the NLM model 320 are: Issue, Help, PayPal, Website, Password, Login, When, Hacked, How long, Steps, Get rid of password issue, Occurred again.

It is understood that for both the NLM models 310 and 320, the list of words listed herein are merely non-limiting examples and are not meant to be exhaustive. The NLM models in the real world may contain many more words that those listed herein. In addition, it is understood that the customized nature of the NLM models 310 and 320 means that the same type of issues (e.g., refunds) may result in different models for different customers, since difference customers may speak in different styles (even to express the same underlying idea). For example, one customer may say “I need help”, while another customer may say “I require assistance.” As such, these customers may have different NLM models not just for different issues (e.g., refunds versus password issues), but also for the same issue (e.g., refunds) as well.

Referring back to FIG. 2B, in steps 8, 9, and 10 of the process flow 200, the steps 5, 6, and 7—which are performed for a customer—are repeated for a customer service agent. For example, whereas step 5 determines mother and child NLM models for a customer, step 8 determines the mother and child NLMs for a customer service agent. Whereas step 6 determines the affinity between mother and child NLM models for the customer, step 9 determines affinity between the mother and child NLMs for the customer service agent. Whereas step 7 establishes the specialized NLMs for the customer, step 10 establishes the specialized NLMs for the customer service agent. The customer service agent may be a human agent in some embodiments, or it may be a computerized chatbot in other embodiments.

Some of the NLM models for customer service agents (e.g., teammates) are also illustrated in FIG. 3. For example, an NLM model 330 may be customized for a teammate_1 who specializes in resolving refund issues. Some of the key words included in the model 330 are: Contact intent, PayPal, committed, I understand, Assist, Refund, Process, Pending, ETA, Date/Time, Timezone, Merchant name, Credited, Check again. As another example, an NLM model 340 may be customized for a teammate_2 who also specializes in resolving refund issues. Some of the key words included in the model 340 are: Thanks, Contacting us, Issue, PayPal, Committed, I Understand, Assist, Refund, Underway, ETA, Date/Time, Timezone, Merchant name, Credited, Check yourself, PayPal site. Note that some of the key words may appear in both the NLM model 330 and the NLM model 340, but other key words may be unique to either the NLM model 330 or the NLM model 340. Again, this is because the models are customized to each agent individually, and since different agents may use different words or phrases to convey the same ideas, even if these agents are specialized in the same area.

As was the case for the NLM models 310 and 320, the list of words listed in the NLM models 330 and 340 are merely non-limiting examples and are not meant to be exhaustive. The NLM models in the real world may contain many more words that those listed herein. In addition, it is understood that the NLM models (such as the NLM model 350) may be customized for a plurality of other agents and/or a plurality of other issues, but the contents for these other agent models are not specifically listed herein for reasons of simplicity.

Referring now to FIG. 2C, step 8 may be associated with a step 8a and a step 8b. For example, in step 8a, a set of agent availability rules may be accessed. The set of agent availability rules in step 8a may specify which of the agents should be made available to help the customer (e.g., via an electronic conversation). In step 8b, a cache of agent identifiers may be refreshed to create on-demand time-to-live (TTL)-based agent NLMs.

Referring back to FIG. 2B, in a step 10a of the process flow 200, the affinity scores between the mother and child NLM models may be dynamically changed based on new facts and/or new utterances by the customer. In some embodiments, the new facts may pertain to actions taken by the customer since the initial customer event was initiated. For example, the customer may edit or cancel the initial customer event, or initiate a new customer event. In some embodiments, a new fact may be that the customer is utilizing a different channel to establish contact with the customer service agent. As an example, the customer may have previously used an online chat as a channel to establish contact with the customer service agent. However, it has been determined that the customer has now sent an email as an additional or alternative channel to establish contact with the customer service agent, and this new line of communication may be considered a new fact as well.

The new utterances may be additional electronic conversations that have taken place involving the customer after the initial customer event, and/or the findings of additional electronic conversations involving the customer after the initial customer event. In some embodiments, the new facts or utterances need not necessarily be actual facts or utterances involving the customer, but they may include simulated facts or utterances involving the customer as well. For example, the ECP module 198 may predict that the customer will engage in a new action (e.g., request a refund or cancel an account) after the initial customer event (e.g., transaction dispute), and that predicted new action may be considered a new fact. As another example, the ECP module 198 may predict certain sentence(s) to be uttered by the customer in an electronic conversation with a customer service agent, and/or the sentence(s) to be uttered by the customer service agent in an electronic conversation with the customer. These predicted sentences may be considered new utterances. It is understood that the new facts or new utterances are merely non-limiting examples of additional information that may be received from the user after the initial customer event. Other types of additional information may also be taken into account to help update the automatically generated simulated electronic conversation based on the additional information.

Regardless of how the new facts and/or utterances are obtained, the affinity scores may be dynamically adjusted based on these new facts and/or utterances accordingly in step 10a.

Based on the adjusted affinity scores, the ECP module 198 may assign a new mother NLM model, and/or assign new child NLM models to the same mother NLM model. For example, a mother NLM model of transaction dispute may be initially determined for a customer, and a child NLM model of refund may be assigned for that mother NLM model, based on the previous facts and/or utterances by the customer. However, after analyzing the new facts and/or utterances by the customer (e.g., the customer actually saying “I want to talk about my checkout process” or having been predicted as saying “I want to talk about my checkout process”), the ECP module 198 may determine that the customer is actually more interested in the checkout process, as opposed to a refund. The affinity scores between the mother NLM model of transaction dispute and the child NLM model of refund and the child NLM model of checkout process may be updated accordingly, and the child NLM model of checkout process may be assigned to the mother NLM model of transaction dispute to replace the child NLM model of refund previously assigned to the mother NLM model of transaction dispute.

The process flow 200 continues in step 11, in which a contact arrival recommender sub-module of the ECP module 198 is launched. The contact arrival recommender sub-module may predict the time frame (e.g., within xx minutes) within which the customer will contact the customer service agent regarding the issue that needs to be resolved (e.g., a refund). For example, the contact arrival recommender sub-module may predict that the customer will contact the customer service agent in the next 15 minutes after initiating the customer event of step 1. Based on this prediction, step 11a of the process flow 200 finalizes the sentences off the final NLM models, and step 11l of the process flow integrates the NLM models with one or more large language models (LLMs), which may either be supplied externally or in-house (e.g., by the platform associated with the ECP module 198), and/or both. By executing the steps of 11, 11a, and 11b, the process flow 200 ensures that the adequate mother and child NLM models are ready for deployment and utilization before the customer begins an actual conversation with the customer service agent.

Referring now to FIG. 2C, step 12a of the process flow 200 determines a final omnichannel context (in a high latency cache situation) with the NLMs of the customer and the teammate group. In more detail, there may be hundreds, thousands, or even tens of thousands of teammates (e.g., customer service agents, which may be a human or a computerized bot). Each of the teammates may have a different skill set and may specialize in a different aspect of servicing customers. Teammates having similar skill sets and/or specializing in the same aspect of servicing customers may belong to the same teammate group. For example, teammates in a refund teammate group may also have specialized skills in resolving refund issues, and teammates in a password issue group may also have specialized skills in resolving customer password issues. Nevertheless, it is understood that even within the same teammate group, the individual teammates may still have differentiable skill sets. For example, a teammate A may be more skilled in the technical aspects of helping a customer, whereas a teammate B may be more skilled in dealing with rude or otherwise demanding customers. The NLM models at a teammate group level may be stored in high latency cache, where speed is not a paramount concern. In the simplified example of FIG. 2C, step 12a of the process flow 200 may determine the NLM models of the refund teammate group, which is associated with the top 10 available agents for refunds. The NLM models of the refund teammate group may be stored in high latency cache and can be accessed by the ECP module 198 when needed.

Still referring to FIG. 2C, step 12b of the process flow 200 may define an expiration time for the high latency cache. Data across various apps may also be loaded and/or refreshed to ensure that the latest (e.g., most recent or up-to-date data is available for access). Note that the steps 12a and 12b are performed at the level of “high latency cache.”

Referring back to FIG. 2B, step 13 of the process flow 200 establishes a final pre-contact context for the customer and the agent at an agent group level. As a non-limiting example, the final pre-contact context may include a propensity-to-contact score (e.g., 0.83), a customer account identifier (e.g., C124), a likely (e.g., predicted) intent (e.g., a request for a refund), a likely next intent (e.g., password issue), and likely contact channels (e.g., chatbot followed by a teammate). The final pre-contact context may also include a mother NLM model that is customized for the customer (e.g., an NLM model named NLM_Mother_Refund_customerID_123), a child NLM model that is customized for the customer (e.g., an NLM Model named NLM_Child_PasswordIssue_customerID_123), where the affinity score between the mother and child NLM models is 90%. The final pre-contact context may further include a mother NLM model that is customized for the teammate group (e.g., an NLM model named NLM_Mother_Refund_TeammateGROUP_TGRP_REFUND), a child NLM model that is customized for the teammate group (e.g., an NLM Model named NLM_Child_PasswordIssue_TeammateGROUP_TGRP_PASSWORDISSUE), where the affinity score between the mother and child NLM models is 60%. Again, the sentences off the final NLM models in step 13 are at the level of the customer and at the level of the agent group (e.g., an agent group that comprises multiple agents (e.g., teammates)).

Referring now to FIG. 2C again, steps 14a and 14b of the process flow 200 are performed substantially similarly as steps 12a and 12b of the process flow 200, respectively, with the exception that the steps 14a and 14b are performed at a low latency cache level, which is for a specific agent (e.g., an exact teammate). As such, the final omnichannel context with the NLMs of steps 14a and 14b may be stored and accessed in a low latency cache, where the speed of access is faster than the high latency cache. It is understood that the relatively high speed of the low latency cache may be beneficial when the simulated sentences in an electronic conversation between the customer and the agent need to be properly sequenced.

Referring now to FIG. 2A, step 14c and step 14d of the process flow 200 are performed at the level of “customer's omnichannel context.” In more detail, step 14c is a decision step to determine, based on the specific circumstances in each customer's case, whether low latency cache or high latency cache should be used. In some embodiment, a low latency cache is configured to provide the response within 25 milliseconds given that the meta data has higher likelihood of getting consumed. For example, the low latency cache may contain pre-computed data, such as the exact agent ID to whom the interaction will be routed. On the other hand, the response speed of high latency cache can be double or 1.5 times that of low latency cache, given that it has relatively lower probability of getting used. The higher response time will account for just in time compute (for instance, determining the exact agent ID at the time of routing the interaction, because initially high latency cache will contain agent group, which will have all the agent IDs). In addition, it is also possible that in rare circumstances either one would exist. If such a scenario arises, it will be best to sustain the low latency cache. In the exampled illustrated in FIG. 2A, the decision from step 14c indicates that the low latency cache should be used, and therefore the final omnichannel context involves the NLM models of the customer and the exact agent having the requisite skill (e.g., refund) needed to resolve the predicted issue of the customer. In other embodiments where the decision step indicates that the high latency cache should be used, the final omnichannel context may involve the NLM models of the customer and the agent group having the requisite skill (e.g., refund) needed to resolve the predicted issue of the customer.

Referring back to FIG. 2B, step 15 of the process flow 200 establishes a final pre-contact context for the customer and the agent at a specific agent level. The final pre-contact context of step 15 may be substantially similar to that of step 13, with the difference being that the mother and child NLM models are generated for the specific agent, rather than for an agent group. For example, the final pre-contact context of step 15 may further include a mother NLM model that is customized for the specific agent (e.g., an NLM model named NLM_Mother_Refund_TeammateID_T8902), and a child NLM model that is customized for the specific agent (e.g., an NLM Model named NLM_Child_PasswordIssue_TeammateID_T8902), where the affinity score between the mother and child NLM models is 60%. Again, the sentences off the final NLM models in step 15 are at the level of the customer and at the level of the specific agent.

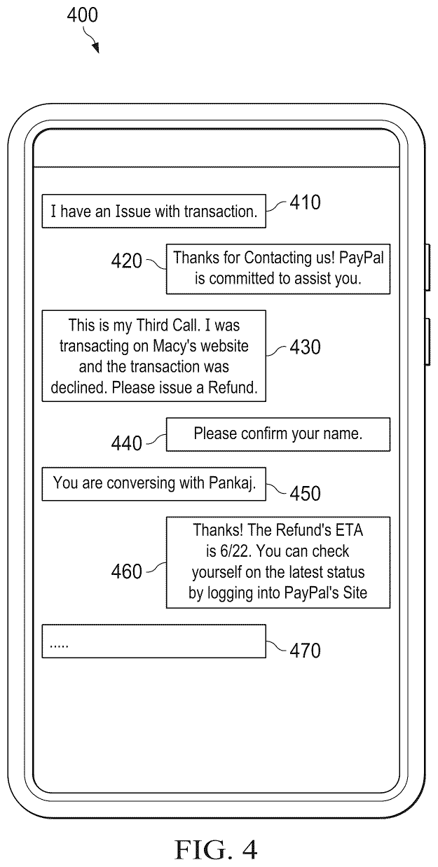

Still referring to FIG. 2B, the process flow 200 may predict a conversation sequence involving the customer at step 16a or step 16b. At step 16a, the predicted conversation sequency may involve the customer and an agent group (e.g., at the agent group level based on the final pre-contact context of step 13). At step 16b, the predicted conversation sequency may involve the customer and a specific agent (e.g., at the specific agent level based on the final pre-contact context of step 15). The predicted conversation may include a plurality of sequences uttered by both the customer and the agent (or the agent group), where there is a back-and-forth exchange. An example of such a predicted conversation will be discussed in more detail below with reference to FIG. 4. In any case, it is noted that all the steps of FIG. 2B are performed at the level of “smart generative engine capability.” Note that the smart generative engine may be implemented as another sub-module of the ECP module 198 in some embodiments. In other embodiments, the capabilities of the smart generative engine may be encompassed by the ECP MODULE 198 without needing sub-modules.

Referring back now to FIG. 2A, step 17 of the process flow 200 is performed at the level of “customer/system”, where the customer actually contacts the customer service, for example, by initiating an electronic conversation with a customer service agent. In some embodiments, the customer may input one or two sentences, or even just a portion of the one or two sentences, and the ECP module 198 may predict the rest of the electronic conversation between the customer and the customer service agent. For example, the ECP module 198 may generate a plurality of sentences that are predicted to be uttered by the customer and the customer service agent, where each sentence (or multiple sentences) uttered by the customer may be in response to the sentence (or multiple sentences) uttered by the customer service agent, or vice versa.

Such a simulated electronic conversation may be displayed to a human customer service agent, and/or to the customer, and the displayed conversation (if it is displayed at all) may be displayed in full or in part. For example, the entire simulated conversation may be displayed in some embodiments, where the predicted issue is resolved, and the customer may be given an option to indicate whether the predicted issue was accurate and whether the customer still needs help. Alternatively, the simulated conversation may be displayed one or more sentences at a time, and the customer may be given the option to indicate whether the predicted one or more sentences are sufficiently accurate to capture the points that the customer wishes to make. If not, then the customer may manually input one or more sentences to steer the simulated conversation in a certain direction.

As discussed above, the ECP module 198 may dynamically adjust the simulated electronic conversation based on the latest input from the customer. For example, the simulated electronic conversation may be dynamically adjusted by changing the child NLM models assigned to the mother NLM model. In some embodiments, the simulated electronic conversation need not be displayed to the customer. Instead, the ECP module 198 may cause a notification to be displayed to the customer, informing the customer that the issue (predicted by the ECP module 198 based on the simulated conversation) that the customer wishes to resolve has been resolved, or will be resolved (e.g., a refund has been or will be issued). In that case, from the customer's perspective, he/she merely initiated the customer event (e.g., by submitting a transaction dispute), and then the underlying issue (e.g., refund) was proactively resolved without him/her specifically requesting a resolution of that underlying issue, which will improve customer satisfaction. In any case, the process flow 200 may end after step 17.

Referring now to FIG. 4, an example user interface (UI) 400 of a mobile device is illustrated. The example user interface 400 may be the UI of a mobile application executing on a mobile computing device of a customer in some embodiments, or it may be the UI of a desktop or laptop computing device of a customer service agent in some other embodiments.

The UI 400 illustrates a simulated electronic conversation generated by the ECP module 198, where the conversation includes multiple sentences exchanged between a customer and a customer service agent.

For example, the customer may begin the electronic conversation with a sentence 410 that says, “I have an issue with transaction.” The customer service agent may reply with a sentence 420 that says “Thanks for contacting us! PayPal is committed to assist you.” The customer may continue with a sentence 430 that says “This is my third call. I was transacting on Macy's website and the transaction was declined. Please issue a refund.” The customer service agent may respond to the sentence 430 with a sentence 440 that says “Please confirm your name.” The customer then replies with a sentence 440 that says “You are conversing with Pankaj.” The customer service agent then replies with a sentence that says “Thanks! The refund's ETA is 6/22. You can check yourself on the latest status by logging into PayPal's site.” The customer may further respond with a sentence 470, and the customer service agent may further respond to the sentence 470. However, for reasons of simplicity, the sentence 470 and/or the sentences that could potentially follow the sentence 470 are not illustrated herein.

In this simplified example discussed above, the customer may have already initiated a customer event before the electronic conversation shown in the UI 400 began. For example, the customer may have submitted a transaction dispute with Macy's through PayPal™'s website or through PayPal™'s mobile application. Such an action may correspond to step 1 of the process flow 200 discussed above with reference to FIGS. 2A-2C. In addition, the transcripts of the customer's prior interactions with customer service agents may be obtained to establish the initial pre-contact context, as described above in step 4 of the process flow 200. For example, the ECP module 198 may calculate a propensity-to-contact score for the customer based on the above factors and facts, predict a likely customer intent, as well as predict the likely channels of contact.

After establishing the initial pre-contact context (e.g., by performing step 4 of the process flow 200), the ECP MODULE 198 may also establish the final pre-contact context at the customer and agent group level (e.g., by performing step 13 of the process flow 200), and establish the final pre-contact context at the customer and specific agent level (e.g., by performing step 15 of the process flow 200). These pre-contact contexts (e.g., results of the steps 4, 13, and/or 15) may be used as inputs for the smart generative engine (which as discussed above, may be implemented as a sub-module of the ECP MODULE 198) to generate the simulated conversation shown in the UI 400.

In some embodiments, the customer may manually input the initial sentence 410, and the rest of the sentences 420-470 are generated automatically. For example, each of the sentences 420-470 may be generated in response to the preceding sentence(s). The customer may also decide to manually override one or more of the automatically generated sentences. If/when that happens, the ECP MODULE 198 may dynamically adjust the generation of the subsequent sentences, for example, by dynamically changing the assignments between the child and mother NLM models. In other embodiments, the customer need not even manually input the initial sentence 410. Instead, the entirety of the conversation shown in FIG. 4 may be automatically generated by the ECP module 198.

In any case, the ECP MODULE 198 is able to generate an entire simulated electronic conversation between the customer and the customer service agent with little direct input (e.g., if the customer manually inputted the sentence 410) or no direct input (e.g., if the customer did not even manually input the sentence 410) at all, where the simulated electronic conversation addresses the needs (e.g., getting a refund issued) of the customer. In this manner, the present application is a practical application of the idea of generating texts that simulate human speech. In such a practical application, the automatically generated electronic conversation (e.g., shown in the UI 400) is not a collection of random meaningless sentences. Rather, each sentence is specifically generated based on the prior inputs (e.g., preceding sentences and the NLM models associated therewith), with the correct sequencing such that the electronic conversation flows logically and makes intuitive sense to a reader (e.g., the customer or a human customer service agent). The customer and the customer service agent are spared of having to chat with the other party in what would otherwise be a time-consuming process. Instead, the automatically generated entire electronic conversation allows either party to see what would have been the result of the time-consuming chat session from the beginning. Consequently, customer satisfaction may be improved and less time and resources are needed to address the back and forths of typical chat conversations.

Furthermore, the present disclosure is an improvement of computer technology, as conventional methods and techniques lack the capability to generate the entire electronic conversation. By generating the entire electronic conversation, the present disclosure also improves computer efficiency and reduces electronic waste, since maintaining a conventional electronic chat session between a customer and a customer service agent would have consumed (and wasted) computer resources (e.g., computer processing power, electronic memory usage, electronic communication bandwidth, etc.). The present disclosure also frees up not only human customer service agents from having to chat with customers, but also computerized bots too. In other words, whereas many instances of computerized bots would have been needed to help customers in conventional situations, the present disclosure significantly avoids the deployment of the computerized bots, which also frees up electronic resources as a part of the improvement in computer technology.

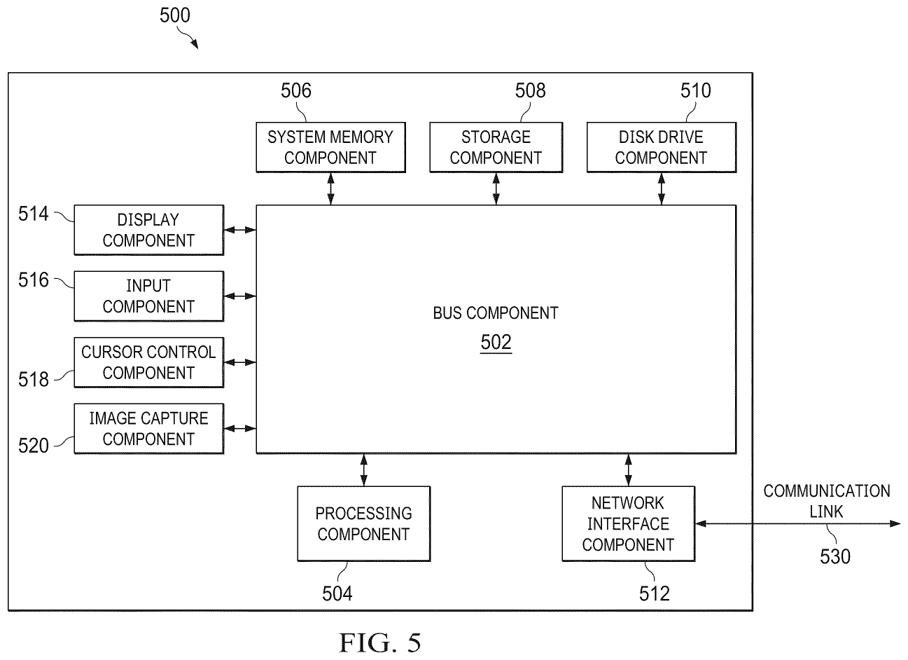

FIG. 5 is a block diagram of a computer system 500 suitable for implementing various methods and devices described herein, for example, the user device 110, the merchant server 140, and/or the payment provider server 170, or a standalone ECP module 198. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the ECP module 198 and the various method steps of the method 800 discussed below (or the user device 110, the merchant server 140, or the payment provider server 170) may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the ECP module 198 may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the ECP module 198 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the ECP module 198 and external devices, for example with the user device 110, with the merchant server 140, or with the payment provider server 170, depending on exactly where the ECP module 198 is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the ECP module 198 may be implemented as such software code.

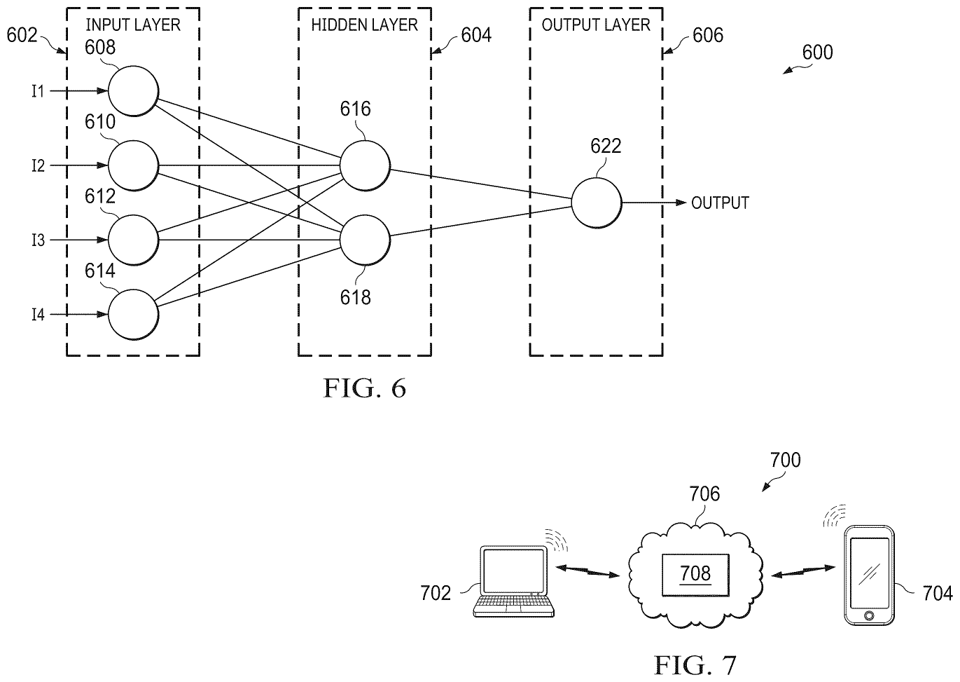

As discussed above, machine learning may be used to predict the intent of the customer and/or to generate the NLM models. In some embodiments, the machine learning may be performed at least in part via an artificial neural network, which may be used to implement a machine learning module that can perform the machine learning processes discussed above. In that regard, FIG. 6 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the ECP module 198, and the ECP module 198 may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct attribute of an analyzed language usage pattern of a user.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement the machine learning module, the output value produced by the artificial neural network 600 may indicate a likelihood of an event (e.g., a prediction respect to a customer's intent).

The artificial neural network 600 may be trained by using training data. For example, the training data herein may be the NLP analysis done on the textual data of one or more reference users. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the determined (predicted) likelihood is inconsistent with whether the event actually occurred for the transaction, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the ECP module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the NLM modeling and the machine learning as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

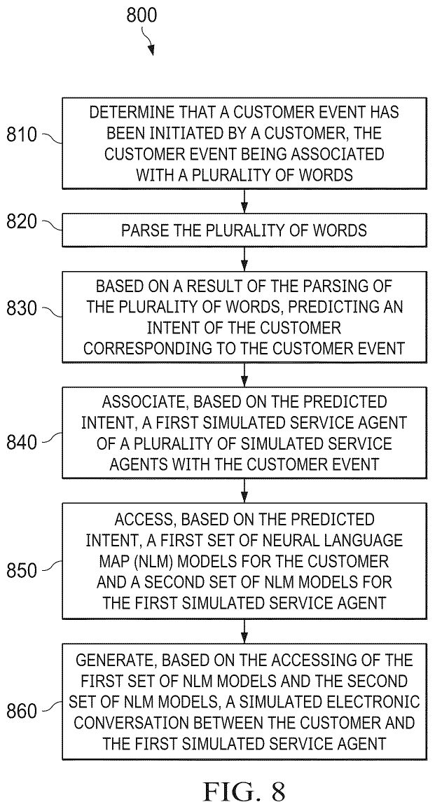

FIG. 8 is a flowchart illustrating a method 800 for generating a simulated electronic conversation according to various aspects of the present disclosure. The various steps of the method 800, which are described in greater detail above, may be performed by one or more electronic processors, for example by the processors of a computer of an entity that may include: a payment provider, a business analyst, or a merchant. The networked system described with respect to FIG. 1 is an example of a system that can perform the method 800. In some embodiments, at least some of the steps of the method 800 may be performed by the ECP module 198 discussed above.

The method 800 includes a step 810 to determine that a customer event has been initiated by a customer. In some embodiments, the customer event is associated with a plurality of words. For example, the customer event may correspond to a customer logging into a website or an electronic application of a platform, where the user may submit a request. In some embodiments, the request may include a submission of a complaint. In some embodiments, the step 810 may correspond to the step 1 of FIG. 2A discussed above.

The method 800 includes a step 820 to parse the plurality of words. For example, an electronic scan may be performed with respect to the words associated with the customer event. In some embodiments, the electronic scan may involve an NLP process. In some embodiments, the step 820 may correspond to the steps 1 and 2 of FIG. 2A discussed above.

The method 800 includes a step 830 to predict an intent of the customer corresponding to the customer event. In some embodiments, the prediction is made based on a result of the parsing of the plurality of words. For example, the predicted intent may be that the user wishes to receive a refund for a transaction. In some embodiments, the step 830 may correspond to the steps 2-4 of FIG. 2A discussed above.

The method 800 includes a step 840 to associate, based on the predicted intent, a first simulated service agent of a plurality of simulated service agents with the customer event. In some embodiments, the first simulated service agent is a computerized chatbot. For example, an affinity score between the mother NLM model and the child NLM model may be determined for the customer and for the agent. In some embodiments, the step 840 may correspond to the steps 5-6 and 8-9 of FIG. 2B discussed above.

The method 800 includes a step 850 to access, based on the predicted intent, a first set of Natural Language Map (NLM) models for the customer and a second set of NLM models for the first simulated service agent. For example, a different type of NLM model may be established for different types of customer intents. For example, one NLM model may be established for a customer intent to get a refund, while a different NLM model may be established for a customer intent to resolve a password issue. Furthermore, it is understood that the NLM models are established for a specific customer. For example, while a customer A and a customer B may both have the intent of getting a refund, different NLM models may be established for them. The different NLM models for different customers may be attributed at least in part to the different electronic conversations associated with the customers A and B, for example, due to their different styles or manners of conversing. Thus, the NLM models generated herein are customized for individual customers. In some embodiments, the step 850 may correspond to the steps 7 and 10 of FIG. 2B discussed above.

The method 800 includes a step 860 to generate, based on the accessing of the first set of NLM models and the second set of NLM models, a simulated electronic conversation between the customer and the first simulated service agent. For example, the conversation may be in the form of a back-and-forth chat, such as that shown in FIG. 4 discussed above. In some embodiments, the step 860 may correspond to steps 16a-16b of FIG. 2B discussed above.

In some embodiments, the step of 860 comprises: generating, for each of the customer and the first simulated service agent, a plurality of sentences, and sequencing the plurality of sentences. For example, the sequence of the sentences may form the chat discussed above with reference to FIG. 4. In some embodiments, the step 860 may correspond to steps 16a-16b of FIG. 2B discussed above.

It is understood that additional method steps may be performed before, during, or after the steps 810-860 discussed above. For example, the method 800 may include a step of accessing previous electronic chat transcripts involving the customer. In that case, the customer intent is predicted based on the accessing of the previous electronic chat transcripts. In some embodiments, the first NLM models are established at least in part based on performing one or more natural language processing (NLP) processes on the previous electronic chat transcripts. As another example, the method 800 may include a step to calculate a propensity-to-contact score based at least in part on the parsing of the plurality of words. In some embodiments, the predicting the intent according to step 830 is performed in response to the propensity-to-contact score exceeding a predefined threshold. As another example, the method 800 may further include a step of determining, based on the simulated conversation, a request that will be made by the customer at a future point in time. In some embodiments, the method 800 may further include a step of granting the request before the future point in time, and another step of informing the customer about the granting of the request. As another example, the method 800 may further include the following steps: receiving additional input from the customer after the simulated conversation has been generated; altering, based on the received additional input, one or more NLM models in the first set of NLM models or in the second set of NLM models; and re-generating the simulated conversation based on the altered first set of NLM models or the altered second set of the NLM models. In some embodiments, the method 800 may further include the following steps: before the altering, the first set of NLM models comprises a mother NLM model and a first child NLM model having a first affinity score with the mother NLM model that exceeds a specified threshold; and after the altering, the altered first set of NLM models comprises the mother NLM model and a second child NLM model having a second affinity score with the mother NLM model that exceeds the first affinity score.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. A determination is made that a customer event has been initiated by a customer. The customer event is associated with a plurality of words. The plurality of words are parsed. Based on a result of the parsing of the plurality of words, an intent of the customer corresponding to the customer event is predicted. Based on the predicted intent, a first simulated service agent of a plurality of service agents is associated with the customer event. Based on the predicted intent, a first set of Natural Language Map (NLM) models for the customer and a second set of NLM models for the first simulated service agent are accessed. Based on the first set of NLM models and the second set of NLM models, a simulated conversation between the customer and the first simulated service agent is generated. The simulated conversation involves the predicted intent.

Another aspect of the present disclosure involves a system that includes a non-transitory memory and one or more hardware processors coupled to the non-transitory memory and configured to read instructions from the non-transitory memory to cause the system to perform operations comprising: determining that an event has been initiated by a user; accessing a plurality of previous electronic chat transcripts associated with the user; analyzing the event and the plurality of previous electronic chat transcripts; predicting, based on the analyzing, an intent of the user corresponding to the event; assigning, based on the predicted intent, a service agent of a plurality of service agents to the user, the service agent having a skill associated with the predicted intent; determining a first set of Natural Language Map (NLM) models for the user and a second set of NLM models for the service agent; and automatically generating, based on the first set of NLM models and the second set of NLM models, a simulated electronic conversation between the user and the service agent, the simulated electronic conversation comprising a plurality of sentences exchanged between the user and the service agent, wherein at least one of the sentences is associated with the predicted intent.

Yet another aspect of the present disclosure involves a non-transitory machine-readable medium having stored thereon machine-readable instructions executable to cause a machine to perform operations comprising: accessing textual content associated with an event initiated by a user of a platform and textual content of historical electronic chat records involving the user; predicting, based on the textual content of the event and the historical electronic chat records, a concern of the user that has not been specifically raised in association with the event; determining, based on the predicting, a service agent of a plurality of service agents for engaging in a potential interaction with the user, wherein the service agent is determined at least in part based on a match between a skill of the service agent and a skill for addressing the concern; generating a first set of Natural Language Map (NLM) models for the user and a second set of NLM models for the service agent; and simulating, based on the first set of NLM models and the second set of NLM models, an electronic conversation between the user and the service agent in which the concern of the user is addressed.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
determining that a customer event has been initiated by a customer, the customer event being associated with a plurality of words;
parsing the plurality of words;
based on a result of the parsing of the plurality of words, predicting an intent of the customer corresponding to the customer event;
associating, based on the predicted intent, a first simulated service agent of a plurality of simulated service agents with the customer event;
accessing, based on the predicted intent, a first set of Natural Language Map (NLM) models for the customer and a second set of NLM models for the first simulated service agent; and
generating, based on the first set of NLM models and the second set of NLM models, a simulated conversation between the customer and the first simulated service agent, the simulated conversation involving the predicted intent.

2. The method of claim 1, further comprising accessing previous electronic chat transcripts involving the customer, wherein the determining is further based on the previous electronic chat transcripts.

3. The method of claim 2, wherein the first NLM models are established at least in part based on performing one or more natural language processing (NLP) processes on the previous electronic chat transcripts.

4. The method of claim 1, wherein one or more of the determining, the parsing, the predicting, the associating, the accessing, or the generating is performed by one or more hardware processors of a platform on which the customer is a user, and wherein the method further comprises: recommending an action for incentivizing the customer to stay with the platform.

5. The method of claim 1, further comprising: calculating a propensity-to-contact score based at least in part on the parsing of the plurality of words, wherein the predicting the intent is performed in response to the propensity-to-contact score exceeding a predefined threshold.

6. The method of claim 1, further comprising: predicting, based on the simulated conversation, that the customer will a request an action to be taken at a future point in time.

7. The method of claim 6, further comprising:
performing the action before the future point in time; and
informing the customer about the performing of the action.

8. The method of claim 1, wherein the generating the simulated conversation comprises:
generating, for each of the customer and the first simulated service agent, a plurality of sentences; and
sequencing the plurality of sentences.

9. The method of claim 1, further comprising:
receiving additional input from the customer after the simulated conversation has been generated;
altering, based on the received additional input, one or more NLM models in the first set of NLM models or in the second set of NLM models; and
re-generating the simulated conversation based on the altered first set of NLM models or the altered second set of the NLM models.

10. The method of claim 9, wherein:
before the altering, the first set of NLM models comprises a mother NLM model and a first child NLM model having a first affinity score with the mother NLM model that exceeds a specified threshold; and
after the altering, the altered first set of NLM models comprises the mother NLM model and a second child NLM model having a second affinity score with the mother NLM model that exceeds the first affinity score.

11. The method of claim 10, further comprising causing the simulated conversation to be displayed via a user interface of a mobile device.

12. The method of claim 10, wherein the first simulated service agent is a computerized chatbot.

13. A system, comprising:
a non-transitory memory; and
one or more hardware processors coupled to the non-transitory memory and configured to read instructions from the non-transitory memory to cause the system to perform operations comprising:
determining that an event has been initiated by a user;
accessing a plurality of previous electronic chat transcripts associated with the user;
analyzing the event and the plurality of previous electronic chat transcripts;
predicting, based on the analyzing, an intent of the user corresponding to the event;
assigning, based on the predicted intent, a service agent of a plurality of service agents to the user, the service agent having a skill associated with the predicted intent;
determining a first set of Natural Language Map (NLM) models for the user and a second set of NLM models for the service agent; and
automatically generating, based on the first set of NLM models and the second set of NLM models, a simulated electronic conversation between the user and the service agent, the simulated electronic conversation comprising a plurality of sentences exchanged between the user and the service agent, wherein at least one of the sentences is associated with the predicted intent.

14. The system of claim 13, wherein:
the first set of NLM models are unique to the user; and
the second set of NLM models are unique to the service agent.

15. The system of claim 13, wherein the analyzing further comprises performing a natural language processing (NLP) process on a textual content of the event or the plurality of previous electronic chat transcripts.

16. The system of claim 13, wherein the operations further comprise: predicting a future point in time at which the user will submit a request associated with the intent, wherein the simulated electronic conversation is automatically generated before the predicted future point in time.

17. The system of claim 13, wherein the operations further comprise:
receiving additional information from the user regarding the event; and
updating the automatically generated simulated electronic conversation based on the additional information.

18. A non-transitory machine-readable medium having stored thereon machine-readable instructions executable to cause a machine to perform operations comprising:
accessing textual content associated with an event initiated by a user of a platform and textual content of historical electronic chat records involving the user;
predicting, based on the textual content of the event and the historical electronic chat records, a concern of the user that has not been specifically raised in association with the event;
determining, based on the predicting, a service agent of a plurality of service agents for engaging in a potential interaction with the user, wherein the service agent is determined at least in part based on a match between a skill of the service agent and a skill for addressing the concern;
generating a first set of Natural Language Map (NLM) models for the user and a second set of NLM models for the service agent; and
simulating, based on the first set of NLM models and the second set of NLM models, an electronic conversation between the user and the service agent in which the concern of the user is addressed.

19. The non-transitory machine-readable medium of 18, wherein the operations further comprise customizing the first set of NLM models to the user and customizing the second set of NLM models to the service agent.

20. The non-transitory machine-readable medium of 18, wherein the operations further comprise adjusting the simulating of the electronic conversation based on additional input received from the user, wherein the adjusting comprises changing an NLM model of the first set or the second set of the NLM models.
